(19) United States
(12) Patent Application Publication
(10) Pub. No.: US 2026/0203650 A1
(43) Pub. Date: Jul. 16, 2026

(54) SYSTEMS AND METHODS FOR A TELEMATICS MACHINE LEARNING MODEL UNDER A FEDERATED LEARNING FRAMEWORK

(71) Applicant: Quanata, LLC, San Francisco, CA (US)

(72) Inventors: Fang Fang, San Jose, CA (US); Morgan Haire Bugbee, San Marino, CA (US)

(73) Assignee: Quanata, LLC, San Francisco, CA (US)

(21) Appl. No.: 19/022,232

(22) Filed: Jan. 15, 2025

(51) Int. Cl. G06N 20/00

(52) U.S. Cl. CPC G06N 20/00

(57) ABSTRACT

A method can include providing a machine learning model based in part on a user profile for a user. The method can also include transmitting the machine learning model, as compressed, to a mobile user device. The method can further include generating, on the mobile user device, a personalized machine learning model by training the machine learning model, as compressed, based in part on dynamic data of the user. The method can additionally include determining, by the personalized machine learning model on the mobile user device, a risk score of the user. Other embodiments are described.

### FIELD OF THE DISCLOSURE

The present disclosure generally relates to technologies for a telematics machine learning model under a federated learning framework.

### BACKGROUND

Some users of artificial intelligence and machine learning technologies are concerned about the privacy of their personal data. Specifically, such users do not want their personal data to be shared with third parties. Conventional ways of providing machine learning models are a cause of concern for these users who are concerned about the privacy of their personal data. Therefore, systems and methods for providing a machine learning model while limiting the amount of personal data shared with third parties are desirable.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

The drawings show arrangements that are presently discussed, but it is understood that the depicted and/or described embodiments are not limited to the precise arrangements depicted or described. Accordingly:

FIG. 1 illustrates a front elevation view of one or more computer systems and a mobile device that are suitable for implementing at least a portion of an embodiment of the system disclosed in FIG. 3;

FIG. 2 illustrates a representative block diagram of an example of elements included in circuit boards inside the chassis of the computer system of FIG. 1;

FIG. 3 illustrates a system for a telematics machine learning model under a federated learning framework;

FIG. 4 illustrates a flow chart for a method for a telematics machine learning model under a federated learning framework, according to one embodiment; and

FIG. 5 illustrates a method for generating the machine learning model, according to one embodiment.

### DETAILED DESCRIPTION OF THE DRAWINGS

The present embodiments can generally relate to, inter alia, at least one of providing a personalized machine learning model without sharing a user's personal data with a third party, determining a risk score, and/or providing an insurance discount based in part on the risk score. Current machine learning models in the telematics space either (a) share a user's personal data with a third party and create data privacy concerns or (b) are inaccurate because too little information is used to base a prediction of a user's driving risk/behavior.

More specifically, various embodiments can include a method being implemented via execution of computing instructions configured to run on one or more processors and stored on one or more non-transitory computer-readable media. The method can include providing a machine learning model based in part on a user profile for a user, wherein the user profile is based in part on static data about one or more users, and wherein the machine learning model is compressed after the machine learning model is generated. The method can further include, transmitting, by the one or more processors, the machine learning model, as compressed, to a mobile user device. The method can additionally include, generating, on the mobile user device, a personalized machine learning model by training the machine learning model, as compressed, based in part on dynamic data of the user. The method also can include, determining, by the personalized machine learning model on the mobile user device, a risk score of the user. The method also can include additional, less, or alternate functionality, including that discussed elsewhere herein.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations.

The operations can include providing a machine learning model based in part on a user profile for a user, wherein the user profile is based in part on static data about one or more users, and wherein the machine learning model is compressed after the machine learning model is generated. The operations can further include, transmitting, by the one or more processors, the machine learning model, as compressed, to a mobile user device. The operations can additionally include, generating, on the mobile user device, a personalized machine learning model by training the machine learning model, as compressed, based in part on dynamic data of the user. The operations also can include, determining, by the personalized machine learning model on the mobile user device, a risk score of the user. The system can be configured to include additional, less, or alternate functionality, including that discussed elsewhere herein.

In further embodiments, a non-transitory computer readable storage medium storing computing instructions can be provided. The computing instructions, when run on one or more processors, can cause the one or more processors to perform operations including providing a machine learning model based in part on a user profile for a user, wherein the user profile is based in part on static data about one or more users, and wherein the machine learning model is compressed after the machine learning model is generated. The operations can further include, transmitting, by the one or more processors, the machine learning model, as compressed, to a mobile user device. The operations can additionally include, generating, on the mobile user device, a personalized machine learning model by training the machine learning model, as compressed, based in part on dynamic data of the user. The operations also can include, determining, by the personalized machine learning model on the mobile user device, a risk score of the user. The non-transitory computer readable storage medium can be configured to include additional, less, or alternate functionality, including that discussed elsewhere herein.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the methods, systems, and non-transitory computer readable storage media can be used to determine a risk score of the user. In other embodiments, the methods, systems, and non-transitory computer readable storage media can be used to generate an insurance discount. In further embodiments, the methods, systems, and non-transitory computer readable storage media can be used to update dynamic data of the user. In additional embodiments, the methods, systems, and non-transitory computer readable storage media can be used to predict vehicle maintenance needs, design traffic flow optimizations, and develop eco-driving feedback systems, among other use cases.

In many embodiments, the techniques described herein can provide one or more practical applications and technological improvements. The techniques described herein can provide a technical improvement to machine learning models. As a first example, the techniques described herein can be used to provide an improved machine learning model in the telematics space. The techniques described herein can provide improvement over conventional approaches that merely train machine learning models with static data and do not take into consideration any dynamic data. Accordingly, the techniques described herein can be used to take into account dynamic data when providing a machine learning model. As a second example, the techniques described herein can be used to provide a machine learning model that does not share personal data with third parties. The personal data of the user will stay on the user's device. The techniques described herein can provide improvement over conventional approaches that share personal data with third parties.

Machine learning models in the telematics industry aim to provide a solution different than other industries (e.g., healthcare). Other industries generally try to solve a perception problem that often involve a low noise to signal ratio. For example, perception problems may involve transcribing speech, medical diagnosis, generally matching a pattern to a result (e.g., classification). Solutions to these problems generally involve data that is static and do not require low latency. Solutions to these problems also do not involve a feedback loop as the machine learning models used in this space utilize supervised learning. For example, imaging data in healthcare do not need to be processed at the same speeds or continuously reprocessed.

In contrast, machine learning models in the telematics space provide a solution to prediction problems (not perception problems) such as determining a likelihood that a user will file a claim for an automobile accident which involve a high noise-to-signal ratio. The noise-to-signal ratio is high in such prediction problems because many factors are used by the machine learning model to create the prediction, but such machine learning models may still lack the accuracy needed to solve the prediction problem. Driving behavior and the risks involved can also be sporadic and can occur suddenly, without warning, which requires the machine learning models to exhibit low latency. For example, a user normally driving in calm traffic conditions may need to suddenly take a different route due to chaotic traffic conditions. Therefore, machine learning models having low latency are required to retain accuracy of the models for telematics use cases, and machine learning models outside of the telematic industry do not provide a solution to these challenges. Further, data collection in the telematics space do not typically involve imaging data.

### Computer Systems

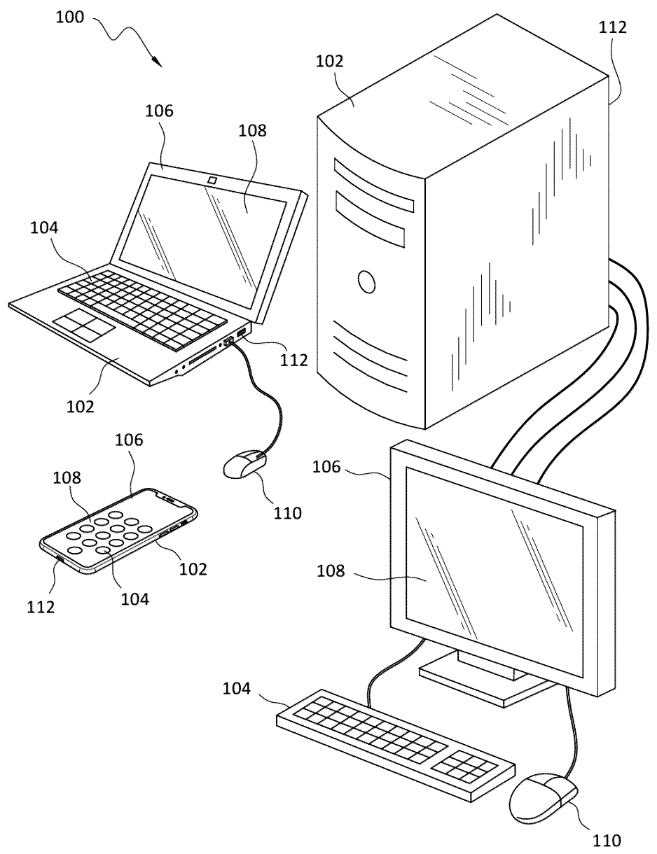

Turning to the drawings, FIG. 1 illustrates an embodiment of three different types (e.g., a laptop, a tower server, and a mobile device) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

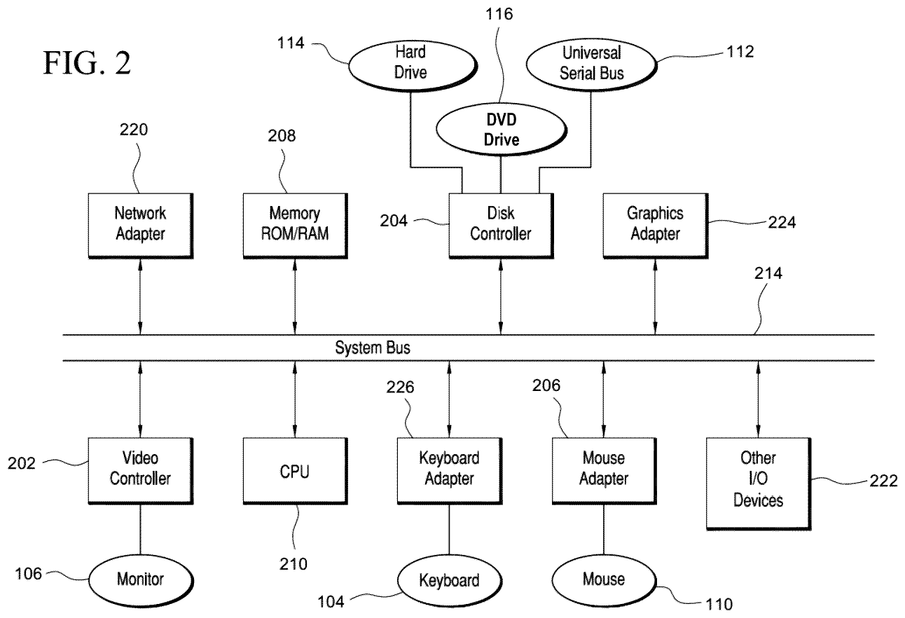

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer, a tower server, and/or a mobile device in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

### Computer Systems for a Telematics Machine Learning Model Under a Federated Learning Framework

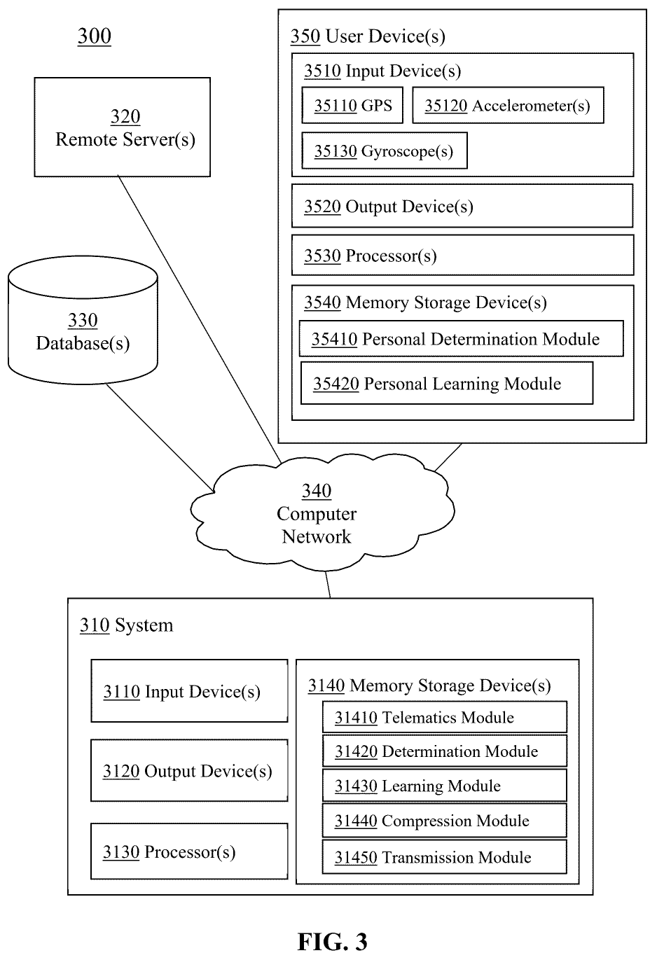

Turning ahead in the drawings, FIG. 3 illustrates a block diagram of a system 300 for providing a personalized machine learning model without sharing a user's personal data with a third party, determining a risk score, and/or providing an insurance discount based in part on the risk score, according to one embodiment. System 300 is an example, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., a system 310), one or more remote servers (e.g., a remote server(s) 320), and/or one or more user devices (e.g., a user device(s) 350). System 310, remote server(s) 320, and user device(s) 350 can each be a computer system, such as computer system 100 (FIG. 1), as described above, and can each be a single computer, a single server, or a cluster or collection of computers or servers, or a cloud of computers or servers. In another embodiment, a single computer system can host each of system 310, remote server(s) 320, and user device(s) 350.

In many embodiments, system 310 can be modules of computing instructions (e.g., software modules) stored on non-transitory computer readable media that operate on one or more processors. In other embodiments, system 310 can be implemented in hardware. In many embodiments, system 310 can comprise one or more systems, subsystems, modules, models, or servers (e.g., a telematics module 31410, a determination module 31420, a learning module 31430, a compression module 31440, a transmission module 31450, etc.). Each of telematics module 31410, determination module 31420, a learning module 31430, a compression module 31440, and a transmission module 31450 can be implemented, at least in part, in software and/or firmware stored in or loaded on memory storage device(s) 3140 and executed on processor(s) 3130. Additional details regarding system 310, remote server(s) 320, and user device(s) 350 are described herein.

In some embodiments, system 310 can be in data communication, through a computer network, a telephone network, or the Internet (e.g., computer network 340), with remote server(s) 320, and/or user device(s) 350. In some embodiments, user device(s) 350 can be used by users, such as drivers of vehicles.

In certain embodiments, system 310 and/or remote server(s) 320 can host one or more websites and/or mobile application servers. For example, system 310 and/or remote server(s) 320 can host a website, or provide a server that interfaces with an application (e.g., a mobile application or a web browser), on user device(s) 350, which can allow users to download gaming interfaces and other interfaces and/or interact with (e.g., play, configure, pause, etc.) gaming interfaces or other interfaces (downloaded or executed on system 310 and/or remote server(s) 320). In some embodiments, an internal network (e.g., computer network 340) that is not open to the public can be used for communications between system 310 and remote server(s) 320 and/or user device(s) 350 within system 300.

In many embodiments, each of user device(s) 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3510 further can include one or more cameras and/or one or more microphones. In the same or different embodiments, input device(s) 3510 can include one or more GPS (Global Positioning System) sensor(s) (e.g., GPS sensor(s) 35110), one or more accelerometers (e.g., accelerometer(s) 35120), and/or one or more gyroscopes (e.g., gyroscope(s) 35130). In the same or different embodiments, user device(s) 350 can comprise one or more systems, subsystems, modules, models, or servers (e.g., a determination module 35410, a personal learning module 35420, etc.). Each of personal determination module 35410 and personal learning module 35420 can be implemented, at least in part, in software and/or firmware stored in or loaded on memory storage device(s) 3540 and executed on processor(s) 3530.

Input device(s) 3510 and output device(s) 3520 can be coupled to their respective user device(s) 350 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of user device(s) 350. In a similar manner, processor(s) 3530 and/or memory storage device(s) 3540 can be local and/or remote to each other.

In certain embodiments, the user devices (e.g., user device(s) 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, smart rings, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, system 310 can include: (a) one or more input devices (e.g., input device(s) 3110 such as one or more keyboards, one or more keypads, one or more pointing devices such as a computer mouse or computer mice, one or more touchscreen displays, a microphone, a camera, etc.), (b) one or more display or output devices (e.g., output device(s) 3120 such as one or more monitors, one or more touch screen displays, projectors, etc.), (c) one or more processors (e.g., processor(s) 3130), and/or (d) one or more memory storage devices (e.g., memory storage device(s) 3140 such as one or more internal or external memory storage units, one or more hard drives, one or more CD-ROM or DVD drives, etc.). In these or other embodiments, one or more of the input device(s) (e.g., input device(s) 3110) can be similar or identical to keyboard 104 (FIG. 1) and/or a mouse 110 (FIG. 1). Further, one or more of the display device(s) (e.g., output device(s) 3120) can be similar or identical to monitor 106 (FIG. 1) and/or screen 108 (FIG. 1). Additionally, one or more of the processors (e.g., processor(s) 3130) can be similar or identical to CPU 210 (FIG. 2). In similar or different embodiments, one or more of the memory storage devices (e.g., memory storage device(s) 3140) can be similar or identical to memory storage unit 208 (FIG. 2), external storage units coupled to input/output 112 port (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 3110) and the display device(s) (e.g., output device(s) 3120) can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 3110) and the display device(s) (e.g., output device(s) 3120) to the processor(s) (e.g., processor(s) 3130) and/or the memory storage unit(s) (e.g., memory storage device(s) 3140). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., a database(s) 330). The one or more databases can include a database that contains information about the demographic and/or geographic information of other users (e.g., insurance policyholders for an insurance company, etc.). The demographic and/or geographic information of the other users can include the ages, genders, residences, insurance policies, premiums, payment history, and/or claim histories for the members, for example, among other information. The same or different databases can include telematics data for such members. The one or more databases additionally can include one or more of trained machine learning (ML) and/or artificial intelligence (AI) models (the ML/AI models) used in system 300 and/or system 310. The one or more databases further can include training datasets for various ML/AI models, modules, or systems. The training datasets can be obtained from a third party, generated manually, curated from historical input/output data of one or more pre-trained ML/AI models, and/or obtained from a group of paid/unpaid users that have opted in to have their personal data collected, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, IBM DB2 Database, and Snowflake.

Meanwhile, system 300, system 310, and/or the one or more databases (e.g., database(s) 330) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc. ; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In many embodiments, system 310 can be configured to transmit, to a user device (e.g., user device(s) 350) of a user, a graphical user interface (e.g., a webpage, a graphical user interface of a mobile application, etc.) for display on the user device. The graphical user interface can include statistics (e.g., distance driven, amount of time driven, number of trips taken, average trip distance, average trip duration, average acceleration, highest acceleration, highest speed, risk score etc.), feedback questions regarding the accuracy of the dynamic data, and other information related to the statics and feedback questions for the user.

### Methods and Computer Instructions for a Telematics Machine Learning Model Under a Federated Learning Framework

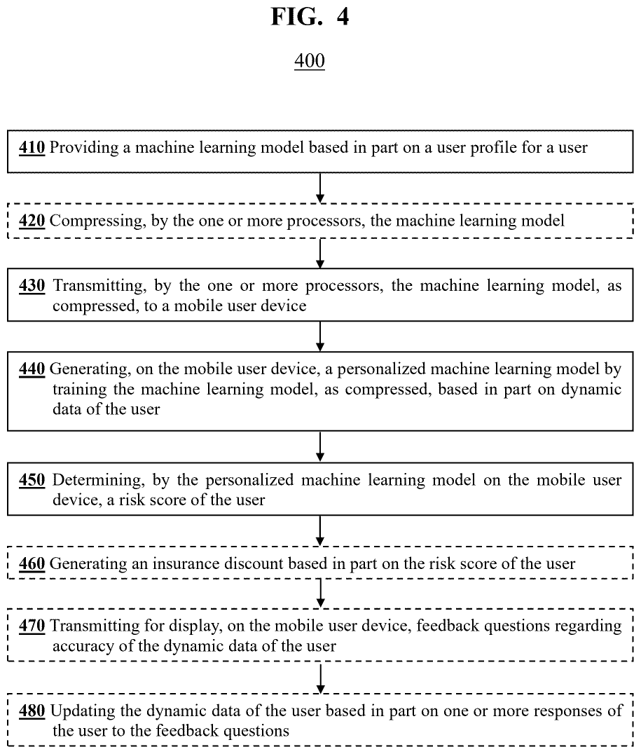

Turning ahead in the drawings, FIG. 4 illustrates actions of a method 400 for generating a personalized machine learning model, determining a risk score of the user, and generating an insurance discount based in part on the risk score of the user, according to certain embodiments. Method 400 can be implemented via execution of computing instructions configured to run on one or more processors and stored on one or more non-transitory computer-readable media. Method 400 is an example and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In many embodiments, system 300 (FIG. 3) or system 310 (FIG. 3) (including one or more of its elements, modules, and/or systems, such as telematics module 31410 (FIG. 3), determination module 31420 (FIG. 3), learning module 31430 (FIG. 3), compression module 31440 (FIG. 3), transmission module 31450 (FIG. 3), personal determination module 35410 (FIG. 3), personal learning module 35420 (FIG. 3), etc.) can be suitable to perform method 400 and/or one or more of the operations, actions, and/or activities of method 400. In different embodiments, each of personal determination module 35410 and personal learning module 35420 can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300, system 310, remote server(s) 320, and/or user device(s) 350. The processor(s) can be similar or identical to the processor(s) described above with respect to computer system 100 (FIG. 1).

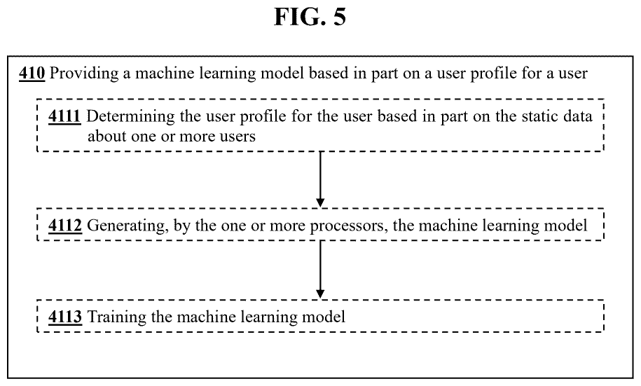

Referring to FIG. 4, in many embodiments, method 400 can include a block 410 of providing a machine learning model based in part on a user profile for a user. Turning to FIG. 5, in some embodiments, block 410 can further include a block 4111 of determining the user profile for the user based in part on the static data about one or more users. In these embodiments, a user profile is determined based in part on static data about the one or more other users by matching the static data of the user to the same or similar static data about the one or more other users. This user profile may include one or more of the user's predicted driving behavior, risk, aggression, etc. The static data may include one or more of driver demographic information (age, sex, location, education, occupation, marital status, ethnicity, etc), insurance related information (liability coverage, collision coverage, length of time user has been insured, etc), past insurance claim information, physical road conditions (potholes, road difficulty, grade of the road, etc), household credit history, traffic citation history, insurance coverage, and vehicle history. The physical road condition of a road may be given a difficulty rating in comparison to the road conditions of other roads.

Continuing with FIG. 5, block 410 further can include a block 4112 of generating by the one or more processors, the machine learning model. Any suitable algorithm can be used, including the algorithms discussed later.

In many embodiments, after block 4112, block 410 can further include a block 4113 of training the machine learning model. In these embodiments a machine learning model can be trained based off the user profile by running a machine learning model on static training data and dynamic training data of the one or more other users matched to the user profile. Any combination of the static data can be used to train the machine learning model (for example, only inputting age, sex, and location). The static training data and the dynamic training data can be retrieved/received from remote server(s) 320 (FIG. 3) and/or database(s) 330 (FIG. 3). Data from the static training data and the dynamic training data can be stored entirely on one of remote servers 320 (FIG. 3) or database(s) 330 (FIG. 3). Data from the static training data and the dynamic training data can also be distributed across remote servers 320 (FIG. 3) and database(s) 330 (FIG. 3).

Returning to FIG. 4, in many embodiments, after block 410, method 400 further can include a block 420 of compressing, by the one or more processors, the machine learning model. In various embodiments, compressing the machine learning model can include utilizing knowledge distillation or model distillation to transfer knowledge of the machine learning model into a compressed machine learning model with minimal loss of validity or without loss of validity. To achieve the compressing of the machine learning model with minimal loss of validity or without loss of validity requires large quantities of data.

In various embodiments, the compressed machine learning model can be further trained to mimic the behavior of the machine learning model using loss functions. One loss function that may be used is contrastive loss. Another loss function that may be used is the Kullback-Leibler (KL) divergence to measure the compressed machine learning model's predictions to a ground truth. The ground truth may be linked to a loss ratio or other business metrics and can be modified.

In the same or different embodiments, the compressed learning model can be further trained using post-quantization. For example, when the model parameter or weights are float32, they can be modified to int8. In various embodiments, quantization aware training can be used. For example, forward propagation may be int8. Backward propagation may be float32 to achieve a low bit parameter.

In many embodiments, after block 420, method 400 further can include a block 430 of transmitting, by the one or more processors, the machine learning model, as compressed, to a mobile user device. This process is advantageous because the compressed learning model is better suited than the machine learning model to operate on a mobile user device, which will have limited memory and processing power compared to a computer server.

In many embodiments, after block 430, method 400 further can include a block 440 of generating, on the mobile user device, a personalized machine learning model by training the machine learning model, as compressed, based in part on dynamic data of the user. This can be done with the use of a transformer architecture or a linear transformation. In various embodiments, the dynamic data of the user can be used to train the compressed machine learning model. The dynamic data of the user cannot be precomputed and changes from every fraction of a second to every minute. The dynamic data also may be contextual. For example, the dynamic data may include the music that the user is playing from a device while operating the vehicle of the user. This data may include the song, artist, genre, length of the song, volume which the user is playing the music at, how often the user adjusts the volume of the music playing or pauses the music.

Dynamic data of the user may include a geolocation of the user, telematics data of a vehicle driven by the user, traffic conditions, operating skill of the user when operating in a traffic condition of the traffic conditions, an quantity of passengers that is riding in the vehicle operated by the user, details about weather that the user is operating the vehicle in, and music that the user is playing while operating the vehicle. For example, the traffic conditions may be a rating (e.g. “S+”, “S”, “A”, “B”, “C”, “D”, “F”, etc.) or a score (e.g. 100. 90, 80, 70, etc.). The operating skill of the user may also be a rating or a score, and each can be associated with the rating or the score of a traffic condition. For example, the operating skill of the user may be a “S” rating when the traffic score is 90 and the operating skill of the user may be C rating when the traffic score is 70. Details about the weather that the user is operating the vehicle in can include sunny, snow, rain, fog, humidity, time of precipitation, duration of precipitation, likelihood of precipitation, temperature, etc.

In various embodiments, block 440 may include training the personalized machine learning model using federated learning. This process provides privacy to the user because the dynamic data of the user is not shared with the remote server(s) 320 (FIG. 3) or database(s) 330 (FIG. 3), or even system 310 (FIG. 3). Therefore, the personalized machine learning model is trained locally by the mobile device of the user using the dynamic data of the user that is collected from the mobile device of the user.

The dynamic data may also include the driver's location, local traffic, and road and weather conditions to help determine how difficult it may be for the driver to navigate that geographic location as well as predict the risk presented by other drivers in that geographic location. It may also be used to determine whether the user is driving in a place familiar or unfamiliar to the user.

In various embodiments, the dynamic data may include telematics data. The telematics data may be collected from the telematics sensors in the user mobile device and/or in the vehicle the user is operating. Examples of the telematics sensors for determining the user motion can include a Global-Positioning-System (GPS) unit, a vehicle speed sensor, a speedometer, etc.

In addition, the dynamic data may include data on other potential driver distractions such as whether the user is talking on the phone or making a call while driving, whether the user is engaged in phone usage such as scrolling social media, responding to text/voice/video messages, watching a show/movie/sports event on the mobile device, video conferencing, etc.

The dynamic data may also include the time of day, day of the week, how many hours the user has been driving continuously, how many hours the user drives in a day, week, and/or month. The dynamic data may further include the battery level of the telematics device such as the mobile user device. For example, the battery level of the telematics device may be used to determine when the telematics device should stop collecting telematics data in order to conserve battery life (e.g., stop collecting telematics data when 20% or less of battery life remains).

The collection and processing of imaging data can introduce high latency and in some embodiments, imaging data can be excluded from the dynamic data to improve latency in the collection and processing of the dynamic data.

The dynamic data may be used to predict the driver's mood and aggression, which may contribute to determining whether the driver is likely to engage in risky driving behavior such as speeding, fast acceleration, ignoring traffic flows, disobeying traffic signals/rules, swerving, driving under the influence, etc.

Continuing with FIG. 4., in many embodiments, after block 440, method 400 further can include a block 450 of determining, by the personalized machine learning model on the mobile user device, a risk score of the user. In various embodiments, the risk score of the user may be determined by the personalized machine learning model. The personalized machine learning model will be capable of recognizing patterns at least from the user's driving data and from the user's dynamic data. The risk score of the user may be determined by weighting the dynamic data of the user alone, or in combination with the static data of the user. For example, a younger user with a more extensive traffic citation history and having higher acceleration telematics data can have a higher risk score than an older user with the same traffic citation history and telematics data. As another example, a user engaged with potential driver distractions (talking on the phone or making a call while driving, phone usage such as scrolling social media while driving, responding to text/voice/video message while driving, watching a show/movie/sports event on the mobile device while driving, video conferencing while driving, etc) can be determined to have a higher risk score than another user who engages in none or less potential driver distractions.

In many embodiments, after block 450, method 400 further can include a block 460 of generating an insurance discount based in part on the risk score of the user. For example, a user with a lower risk score can receive a large insurance discount than a user with a higher risk score. The insurance discount may also be determined at least in part on the consistency of the risk score. For example, if the user's risk score has been consistently low, then a larger discount can be offered for this user than a user who has recently achieved the same or similarly low risk score. In some embodiments, block 460 can also determine an embedding vector of the user.

In many embodiments, after block 460, method 400 further can include a block 470 of transmitting for display, on the mobile user device, feedback questions regarding accuracy of the dynamic data of the user.

In many embodiments, after block 470, method 400 further can include a block 480 of updating the dynamic data of the user based in part on one or more responses of the user to the feedback questions. The feedback questions may ask the user about his driving habits. For example, the user can be asked feedback questions regarding his mood and alertness. The user can also be asked feedback questions on the traffic data, road conditions, and the weather for one or more trips taken. The user may also be asked to confirm his one or more trips, such as the time duration, length, average speed, etc. The user may be asked to confirm the accuracy of his dynamic data. The dynamic data may then be updated based in part on the responses of the user to the feedback questions. Updating the dynamic data may involve adjusting the weights, modifying the dynamic data, resetting/clearing the dynamic data entirely or portions of it. For examples of resetting portions of the dynamic data, the mood can be reset or the music that the user is playing from the device while driving. The dynamic driving data may be rolled back to a previous date based on the user feedback.

In a number of embodiments where one or more ML/AI models are used in block 410, block 420, block 430, block 440, block 450, and/or block 460, method 400 further can include pre-training and/or re-training the trained ML/AI models as the static data stored in the remote server(s) 320 (FIG. 3) or databases 330 (FIG. 3) are updated at predetermined intervals or according to feedback received from a system user (e.g., a data scientist, a machine learning engineer, etc.). In these embodiments, the same or different ML/AI models can be used in one or more of block 410, block 420, block 430, block 440, block 450, and/or block 460 in method 400.

For each of the machine learning models to be retrained, the respective training datasets can be updated manually by a system user (e.g., an ML engineer, a data scientist, etc.) and/or automatically by a system (e.g., system 300 or 310 (FIG. 3)). The system user can select new training data from various data sources (e.g., websites, books, magazines, product catalogs, private third-party databases, etc.). The system can collect new training data based upon various criteria. In certain embodiments, static data and/or output data of the model to be re-trained can be used for re-training the model. In several embodiments, the static data and/or output data of the model can be selected based upon system performance and/or user feedback from the system user associated with the historical output data. In various embodiments, when more than one training dataset is used for the pre-training and/or re-training, the system (e.g., system 300 and/or 310 (FIG. 3)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc.

Relating FIG. 4 to FIG. 3, as an example, telematics module 31410 (FIG. 3) can perform the collection of dynamic data; determination module 31420 (FIG. 3) can perform blocks 410, 460, and 480; learning module 31430 (FIG. 3) can perform block 410; compression module 31440 (FIG. 3) can perform block 420; transmission module 31450 (FIG. 3) can perform block 470; personal determination module 35410 (FIG. 3) can perform blocks 450, 460 and 480; and personal learning module 35420 (FIG. 3) can perform block 440.

### Machine Learning Models

In many embodiments, the systems and/or methods can use one or more ML/AI models to perform one or more of the above-mentioned procedures, processes, activities, actions, operations, and/or methods. Examples of the algorithms used for the various ML/AI models can include BERT, LLM, Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In many embodiments, the systems and/or methods can be configured to train or re-train the one or more ML/AI models. The training of each of the ML/AI models can be supervised, semi-supervised self-supervised, and/or unsupervised - which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In many embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### Additional Considerations

It will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-5 can be modified, and that the foregoing discussion of certain of these embodiments does not necessarily represent a complete description of all possible embodiments. Additionally, one or more of the procedures, processes, operations, actions, and/or activities of the methods in FIG. 4-5 can include different procedures, processes, actions, and/or activities and be performed by many different modules, in many different orders. As another example, the modules, models, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method being implemented via execution of computing instructions configured to run on one or more processors and stored on one or more non-transitory computer-readable media, the method comprising:
providing a machine learning model based in part on a user profile for a user, wherein the user profile is based in part on static data about one or more users, and wherein the machine learning model is compressed after the machine learning model is generated;
transmitting, by the one or more processors, the machine learning model, as compressed, to a mobile user device;
generating, on the mobile user device, a personalized machine learning model by training the machine learning model, as compressed, based in part on dynamic data of the user; and
determining, by the personalized machine learning model on the mobile user device, a risk score of the user.

2. The method of claim 1, wherein:
providing the machine learning model comprises:
determining the user profile for the user based in part on the static data about the one or more users; and
generating, by the one or more processors, the machine learning model;
the method further comprises:
compressing, by the one or more processors, the machine learning model, as generated; and
generating, on the mobile user device, the personalized machine learning model by training the machine learning model, as compressed, based in part on the dynamic data of the user further comprises:
training the machine learning model, as compressed, based in part on the dynamic data of the user and using federated learning.

3. The method of claim 1, wherein generating, on the mobile user device, the personalized machine learning model by training the machine learning model, as compressed, based in part on the dynamic data of the user further comprises:
training the machine learning model, as compressed, based in part on the dynamic data of the user and using a transformer architecture or a linear transformation.

4. The method of claim 1, further comprising:
generating an insurance discount based in part on the risk score of the user, wherein the insurance discount increases when the risk score decreases.

5. The method of claim 1, wherein:
the dynamic data is collected by the mobile user device while the user operates a vehicle.

6. The method of claim 5, further comprising:
transmitting for display, on the mobile user device, feedback questions regarding accuracy of the dynamic data of the user; and
updating the dynamic data of the user based in part on one or more responses of the user to the feedback questions.

7. The method of claim 1, wherein:
the dynamic data of the user comprises at least one of a geolocation of the user, telematics data of a vehicle driven by the user, traffic conditions, operating skill of the user when operating in a traffic condition of the traffic conditions, an quantity of passengers that is riding in the vehicle operated by the user, details about weather that the user is operating the vehicle in, and music that the user is playing while operating the vehicle;
the static data about the one or more users comprise at least one of demographic information of the one or more users, information of one or more mobile user devices, claim history of the one or more users, physical condition of roads, household credit histories, traffic citation histories, and insurance coverage of the one or more users; and
the dynamic data of the user and the static data about the one or more users do not comprise imaging data.

8. A system comprising:
one or more processors; and
one or more non-transitory computer-readable media storing computing instructions that, when run on the one or more processors, cause the one or more processors to perform operations comprising:
providing a machine learning model based in part on a user profile for a user, wherein the user profile is based in part on static data about one or more users, and wherein the machine learning model is compressed after the machine learning model is generated;
transmitting, by the one or more processors, the machine learning model, as compressed, to a mobile user device;
generating, on the mobile user device, a personalized machine learning model by training the machine learning model, as compressed, based in part on dynamic data of the user; and
determining, by the personalized machine learning model on the mobile user device, a risk score of the user.

9. The system of claim 8, wherein:
providing the machine learning model comprises:
determining the user profile for the user based in part on the static data about the one or more users; and
generating, by the one or more processors, the machine learning model;
the operations further comprise:
compressing, by the one or more processors, the machine learning model, as generated; and
generating, on the mobile user device, the personalized machine learning model by training the machine learning model, as compressed, based in part on the dynamic data of the user further comprises:
training the machine learning model, as compressed, based in part on the dynamic data of the user and using federated learning.

10. The system of claim 8, wherein generating, on the mobile user device, the personalized machine learning model by training the machine learning model, as compressed, based in part on the dynamic data of the user further comprises:
training the machine learning model, as compressed, based in part on the dynamic data of the user and using a transformer architecture or a linear transformation.

11. The system of claim 8, wherein the operations further comprise:
generating an insurance discount based in part on the risk score of the user, wherein the insurance discount increases when the risk score decreases.

12. The system of claim 8, wherein:
the dynamic data is collected by the mobile user device while the user operates a vehicle.

13. The system of claim 12, wherein the operations further comprise:
transmitting for display, on the mobile user device, feedback questions regarding accuracy of the dynamic data of the user; and
updating the dynamic data of the user based in part on one or more responses of the user to the feedback questions.

14. The system of claim 8, wherein:
the dynamic data of the user comprises at least one of a geolocation of the user, telematics data of a vehicle driven by the user, traffic conditions, operating skill of the user when operating in a traffic condition of the traffic conditions, a quantity of passengers that is riding in the vehicle operated by the user, details about weather that the user is operating the vehicle in, and music that the user is playing while operating the vehicle;
the static data about the one or more users comprise at least one of demographic information of the one or more users, information of one or more mobile user devices, claim history of the one or more users, physical condition of roads, household credit histories, traffic citation histories, and insurance coverage of the one or more users; and
the dynamic data of the user and the static data about the one or more users do not comprise imaging data.

15. A non-transitory computer readable storage medium storing computing instructions, the computing instructions, when run on one or more processors, causing the one or more processors to perform operations comprising:
providing a machine learning model based in part on a user profile for a user, wherein the user profile is based in part on static data about one or more users, and wherein the machine learning model is compressed after the machine learning model is generated;
transmitting, by the one or more processors, the machine learning model, as compressed, to a mobile user device;
generating, on the mobile user device, a personalized machine learning model by training the machine learning model, as compressed, based in part on dynamic data of the user; and
determining, by the personalized machine learning model on the mobile user device, a risk score of the user.

16. The non-transitory computer readable storage medium of claim 15, wherein:
providing the machine learning model comprises:
determining the user profile for the user based in part on the static data about the one or more users; and
generating, by the one or more processors, the machine learning model;
the operations further comprise:
compressing, by the one or more processors, the machine learning model, as generated; and
generating, on the mobile user device, the personalized machine learning model by training the machine learning model, as compressed, based in part on the dynamic data of the user further comprises:
training the machine learning model, as compressed, based in part on the dynamic data of the user and using federated learning.

17. The non-transitory computer readable storage medium of claim 15, wherein generating, on the mobile user device, the personalized machine learning model by training the machine learning model, as compressed, based in part on the dynamic data of the user further comprises:
training the machine learning model, as compressed, based in part on the dynamic data of the user and using a transformer architecture or a linear transformation.

18. The non-transitory computer readable storage medium of claim 15, wherein the operations further comprise:
generating an insurance discount based in part on the risk score of the user, wherein the insurance discount increases when the risk score decreases, wherein:
the dynamic data is collected by the mobile user device while the user operates a vehicle.

19. The non-transitory computer readable storage medium of claim 18, wherein the operations further comprise:
transmitting for display, on the mobile user device, feedback questions regarding accuracy of the dynamic data of the user; and
updating the dynamic data of the user based in part on one or more responses of the user to the feedback questions.

20. The non-transitory computer readable storage medium of claim 15, wherein:
the dynamic data of the user comprises at least one of a geolocation of the user, telematics data of a vehicle driven by the user, traffic conditions, operating skill of the user when operating in a traffic condition of the traffic conditions, a quantity of passengers that is riding in the vehicle operated by the user, details about weather that the user is operating the vehicle in, and music that the user is playing while operating the vehicle;
the static data about the one or more users comprise at least one of demographic information of the one or more users, information of one or more mobile user devices, claim history of the one or more users, physical condition of roads, household credit histories, traffic citation histories, and insurance coverage of the one or more users; and
the dynamic data of the user and the static data about the one or more users do not comprise imaging data.
